(19) United States
(12) Patent Application Publication
(10) Pub. No.: US 2015/0113245 A1
(43) Pub. Date: Apr. 23, 2015

(54) ADDRESS TRANSLATION GASKET

(71) Applicants: Gregg B. Lesartre, Fort Collins, CO (US); Vincent Nguyen, Houston, TX (US); Patrick Knebel, Fort Collins, CO (US)

(72) Inventors: Gregg B. Lesartre, Fort Collins, CO (US); Vincent Nguyen, Houston, TX (US); Patrick Knebel, Fort Collins, CO (US)

(21) Appl. No.: 14/387,563

(22) PCT Filed: Apr. 30, 2012
(86) PCT No.: PCT/US2012/035776

§ 371 Date: Sep. 24, 2014

(51) Int. Cl. G06F 12/06

(52) U.S. Cl. CPC G06F 12/06; G06F 2212/251
USPC 711/202

(57) ABSTRACT

An example processor includes a plurality of processor core components, a memory interface component, and an address translation gasket. Each processor core component is assigned to one of a plurality of system images, and the plurality of system images share a common memory component by at least utilizing the address translation gasket to maintain separation between memory regions assigned to each of the plurality of system images. The memory interface component is shared by the plurality of independent system images. The address translation gasket is configured to intercept transactions bound for the memory interface component comprising a system image identifier and a target address, generate a translation address based at least in part on the system identifier and the target address, and send the translation address to the memory interface component.

### BACKGROUND

Multi-core processors were introduced to advance the processor technology space when, for the most part silicon processes capabilities exceeded a single core processor's ability to effectively utilize the area available. Unlike a single-core processor, which generally includes a single processor core in a single Integrated circuit (IC), a multi-core processor generally includes two or more processor cores in a single IC. For example, a dual-core processor comprises two processor cores in a single IC, and a quad-core processor comprises four processor cores in a single IC.

Regardless of the number of processor cores in the IC, the benefit of the multi-core architecture is typically the same: enhanced performance and/or efficient simultaneous processing of multiple tasks (i.e., parallel processing). Consumer and enterprise devices such as desktops, laptops, and servers take advantage of these benefits to improve response-time when running processor-intensive processes, such as antivirus scans, ripping/burning media, file searching, servicing multiple external requests, and the like.

### BRIEF DESCRIPTION OF THE DRAWINGS

Example embodiments are described in the following detailed description and in reference to the drawings, in which:

FIG. 1 depicts a processor is accordance with an embodiment:

FIG. 2 depicts a system in accordance with an embodiment:

FIG. 3 depicts a block diagram of translation operations conducted by an address translation gasket is accordance with an embodiment;

FIG. 4 depicts a block diagram of translation operations conducted by the address translation gasket is accordance with another embodiment;

FIG. 5 depicts a block diagram of translation operations conducted by the address translation gasket is accordance with still another embodiment; and

FIG. 6 depicts a process flow diagram in accordance with an embodiment.

### DETAILED DESCRIPTION

Various embodiments of the present disclosure are directed to a multi-core processor architecture. More specifically, various embodiments are directed to a multi-core processor architecture wherein each processor core is allocated to one of a plurality of system images, and the plurality of system images share a common memory component by utilizing an address translation gasket to maintain separation between memory regions assigned to each of the plurality of system images. As described in greater detail below, this novel and previously unforeseen approach provides for more efficient and effective utilization of a single processor socket.

By way of background, there has been recognition that processor densities achievable with current technologies are beyond what a single system image requires for many applications. For these applications, more cores, and in some cases special processing units, do not add value proportional to their incremental costs. Rather, the processing power associated with each core in multi-core processors is often underutilized if utilized at all. While solutions such as “virtualization” and “physicalization” have been introduced to address these inefficiencies, such solutions have their own respective drawbacks. Moreover, they do not squarely address the issue of how to efficiently and effectively utilize each processor core in a multi-core processor. For example, virtualization software (e.g., VMWare) is generally designed to share multiple high-performance processors in a server among multiple system images running under a hypervisor. This software is beneficial because it makes information technology (IT) infrastructure more flexible and simpler to manage. Moreover, it reduces hardware and energy costs by consolidating to a smaller number of highly-utilized servers. However, the virtualization software is often associated with high licensing fees, and the associated hypervisor may be considered a large fault zone or single point of failure. In addition, the virtualization software imposes a performance overhead on the host system. Therefore, while there are various benefits associated with virtualization solutions, there are also various disadvantages associated with the solution.

Physicalization, by contrast, is positioned at the other end of the spectrum from virtualization. Physicalization utilizes multiple light-weight servers comprising lower-performance processors in a dense architecture. The general goal is to achieve maximum value, performance, and/or performance per watt by picking the right size processor for each “micrsoserver” node. The benefit of this approach is that it reduces operating costs by eliminating the need for costly virtualization software, and further by focusing on system packaging efficiency. The drawback, however, is that duplicate components are utilized in each micrsoserver node. For example, input/output components, memory, and/or memory interfaces are redundantly included in each micrsoserver node. Moreover, the “one server, one application” physicalization model is often inflexible and difficult to manage.

Various embodiments of the present application address at least the foregoing by utilizing hardware and/or firmware mechanisms that allow multiple system images to share a single processor socket. Stated differently, various embodiments configure a processor socket to run multiple smaller system images rather then one big system image. While each smaller system images may believe it owns an entire processor socket, in actuality, each system image may be running on a portion of the processor socket and sharing processor components with other system images.

This inventive architecture is realized, in part, by implementing an address translation gasket between the processor cores and a memory interface component. The address translation gasket is configured to maintain separation between the system images, and to allow sharing of a common memory while at the same time preventing access to unauthorized regions of memory. The inventive architecture is further realized by allocating processor cores to different system images, and by sharing high cost and often underutilized components such as input/output and memory by the different system images. As a result, the cost per system image may be reduced, processor cores and associated components may be efficiently utilized, and risk may be mitigated. For example, when compared to virtualization solutions, hypervisor licensing fees and the large fault domain may be eliminated. When compared to physicalization, inflexible provisions and redundant components may be eliminated. Hence, the architecture addresses drawbacks associated with virtualization and physicalization, while at the same time advancing processor efficiency to a level previously unforeseen. This inventive architecture is described further below with reference to various example embodiments and various figures.

In one example embodiment of the present disclosure, a processor is provided. The processor comprises a plurality of processor core components, a memory interface component, and an address translation gasket. Each processor core component is assigned to one of a plurality of system images, and the plurality of system images share a common memory component by at least utilizing the address translation gasket to maintain separation between memory regions assigned to each of the plurality of system images. The memory interface component is shared by the plurality of independent system images. The address translation gasket is configured to intercept transactions bound for the memory interface component comprising a system image identifier and a target address, generate a translation address based at least in part on the system identifier and the target address, and send the translation address to the memory interface component.

In a further example embodiment of the present disclosure, another processor is provided. The processor comprises a plurality of processor core components and an address translation gasket. The plurality of processor core components are each assigned to one of a plurality of system images, and the plurality of system images share a common memory component by at least utilizing the address translation gasket to maintain separation between memory regions assigned to each of the plurality of system images. The address translation gasket is configured to intercept transactions bound for a memory interface component from the plurality of processor core components, and generate translation addresses for the transactions based at least in part on a system image identifier and address associated with the transactions. The address translation gasket is further configured to intercept transactions bound for the plurality of processor core components from the memory interface component, and generate translation addresses for these transactions.

In yet another example embodiment of the present disclosure, a further processor is provided. The processor comprises a plurality of processor core components, a memory interface component, and an address translation gasket. The plurality of processor core components are each assigned to one of a plurality of system images, and the plurality of system images share a common memory component by at least utilizing an address translation gasket to maintain separation between memory regions assigned to each of the plurality of system images. The memory interface component is shared by the plurality of independent system images. The address translation gasket is configured to intercept transactions bound for the memory interface component from the plurality of processor core components, wherein the transactions each comprise a system image identifier and a target address, and wherein the address translation gasket is configured to generate a translation address based at least in part on the system identifier and the target address by at least one of (i) treating the system identifier as one or more additional address bits and concatenating the one or more additional address bits with the target address to produce the translation address; (ii) mapping the system identifier to a fixed address offset, and adding the fixed address offset to the target address to produce the translation address; and (iii) mapping the system identifier and at least a portion of the target address to an assigned portion of memory.

As used herein, a “system image” is intended to refer to a single computing node running a single operating system (OS) and/or hypervisor instance, and comprising at least one processor core, allocated memory, and allocated input/output component.

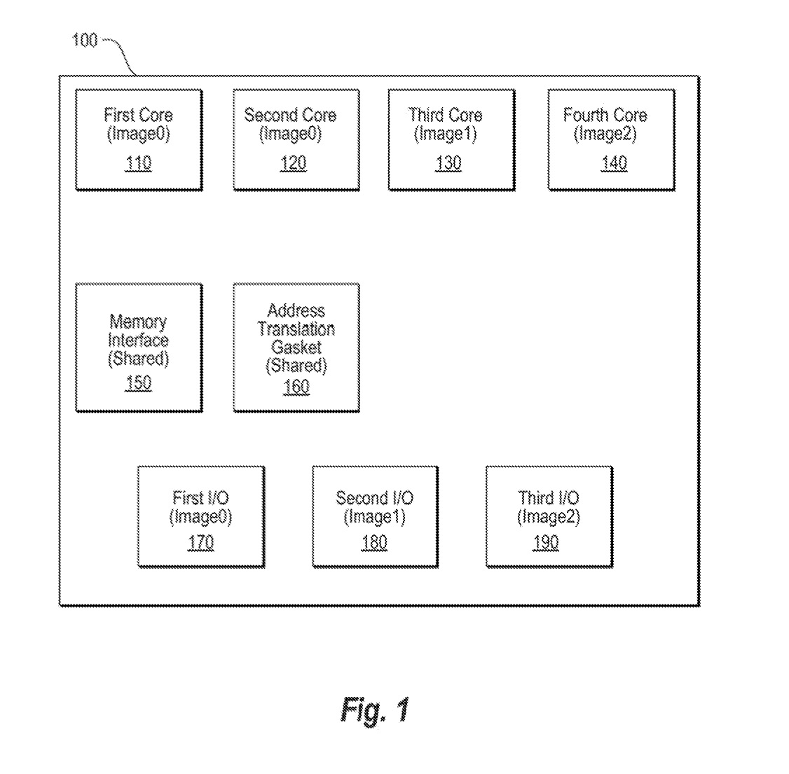

FIG. 1 depicts a processor 100 in accordance with an embodiment. The processor 100 comprises a plurality of processor cores (110-140), a memory interface component 150, an address translation gasket 160, and a plurality of input/output components (170-190), each of which described in greater detail below, it should be readily apparent that the processor 100 depicted in FIG. 1 represents a generalized illustration and that other components may be added or existing components may be removed, modified or rearranged without departing from the scope of the processor 100.

Each processor core (110-140) is a processing device configured to read and execute program instructions. Each core (110-140) may comprise, for example, a control unit (CU) and an arithmetic logic unit (ALU). The CU may be configured to locate, analyze, and/or execute program instructions. The ALU may be configured to conduct calculation, comparing, arithmetic, and/or logical operations. As a whole, each core may conduct operations such as fetch, decode, execute, and/or writeback. While only four processor cores are shown in FIG. 1, it should be understood that more or less processor cores may be included in the processor 100 in accordance with various embodiments. Furthermore, it should be understood that the processor cores (110-140) do not have to be identical, and can vary in terms of processing power, size, speed, and/or other parameters. For example, two processor cores may comprise more processing power than two other processor cores on the same processor 100. Furthermore, while shown as separate components in FIG. 1, it should be understood that the components may be integrated with one another. For example, the address translation gasket 160 and memory interface component 150 may be integrated with one another.

The memory interface component 150 is configured to interface with one or more memory components (not shown in FIG. 1), and to manage the flow of data going to and from the one or more memory components. For instance, each memory interface component may contain logic configured to read from the one or more memory components, and to write to the one or more memory components.

The address translation gasket 160 is configured to intercept transactions bound for the memory interface component 150, and to obtain a target address and a system image identifier from each transaction. The address translation gasket 160 may use the system image identifier to identify a memory region assigned to the system image. This may be accomplished, for example, by applying an offset, or by providing a lookup function to map blocks of the system image's address space to locations in the shared memory pool. The address translation gasket 160 may then generate a translation address and check to ensure that the translation address does not reach beyond the memory range allocated to the system image before transmitting the translation address to the memory interface component 150. The memory interface component 150 may operate solely on the translated transaction it receives. Since addresses associated with different system images are not allowed to overlap, coherency flow naturally works in the environment. Once accesses are processed in the memory interface, the address translation gasket 150 also provides a reverse address translation to convert addresses bound for the system cores (110-140) back to values the cores (110-140) expect.

Each input/output component (170-190) is configured to provide for the data flow to and from the processor's other internal components (e.g., the processor cores) and components outside of the processor on the board (e.g., a video card). Example input/output components may be, for example, configured in accordance with peripheral component interconnect (PCI), PCI-extended (PCI-X), and/or PCI-express (PCIe). Such input/output component may serve as a motherboard-level interconnects, connecting the processor 100 with both integrated-peripherals (e.g., processor mounted integrated circuits) and add-on peripherals (e.g., expansion cards). Similar to described above with respect to the processor cores, it should be understood that the input/output components (170-190) on the processor 100 do not have to be identical, and each can vary in terms of capabilities, for example.

In various embodiments, the plurality of processor core components (110-140), the memory interface component 150, the address translation gasket 160, and the plurality of input/output components (170-190) may be integrated onto a single integrated circuit die. Alternatively, in various embodiments, the plurality of processor core components (110-140), the memory interface component 150, the address translation gasket 160, and the plurality of input/output components (170-190) may be integrated onto multiple integrated circuit dies in a single chip package. Regardless of the implementation, the plurality of processor core components (110-140), the memory interface component 150, the address translation gasket 160, and the plurality of input/output components (170-190) may be communicatively coupled via one or more communication busses.

Turning now to the processor 100 operation, various embodiments of the present disclosure deploy multiple system images on the single processor 100. The system images may be independent insofar as one system image may not be influenced, controlled, and/or dependent upon another system image. The system images may be isolated insofar as each system image may be separated from one another such that information with respect to one system image may not be accessible by another system image. For example, a system image with a first company's data may not be influenced or accessible by a system image with a second company's data, even though both run on a single processor. This may be accomplished, in part, by operations conducted at the address translation gasket 160. In particular, the address translation gasket 160 is configured to intercept transactions bound for the memory interface 150 and from the processor cores (110-140). The address translation gasket 160 obtains at least a target address and a system image identifier from each intercepted transaction, and generates a translation address based on the target address and/or the system image identifier (e.g., by mapping the target address and/or a system image identifier to an assigned address range in a physical memory). The address translation gasket 160 then provides this translation address to the memory interface 150. As a result, the address translation gasket 160 is able to act as an intermediate between the processor cores (110-140) and the memory interface 150, and thereby control which portion of memory the processor cores (110-140) access, as well as ensure that the processor cores (110-140) are not accessing portions of memory outside the portion(s) allocated to the respective processor core(s). The address translation gasket 160 provides similar reverse translation functions for transactions from the memory interface 150 and bound for the processor cores (110-140). In this direction, the address translation gasket 160 reverse translates the transaction such that the processor cores (110-140) receive expected transaction values.

With respect to allocation between processor cores (110-140) and system images, each of the plurality of processor cores (110-140) may be allocated to a different independent and isolated system image. Alternatively or in addition, a group processor cores (110-140) may be allocated to an independent and isolated system image. For example, as shown in FIG. 1, the first processor core 110 and the second processor core 120 may be allocated to system image #0, the third processor core 130 may be allocated to system image #1, and the fourth processor core may be allocated to system image #2.

Other processor components may be similarly allocated or shared by one or more of the system images. For example, as shown in FIG. 1, the first input/output component 170 may be allocated to system image #0, the second input/output component 160 may be allocated to system image #1, and the third input/output component 190 may be allocated to system image #2. Further, the memory interface 150 may be shared by each system image.

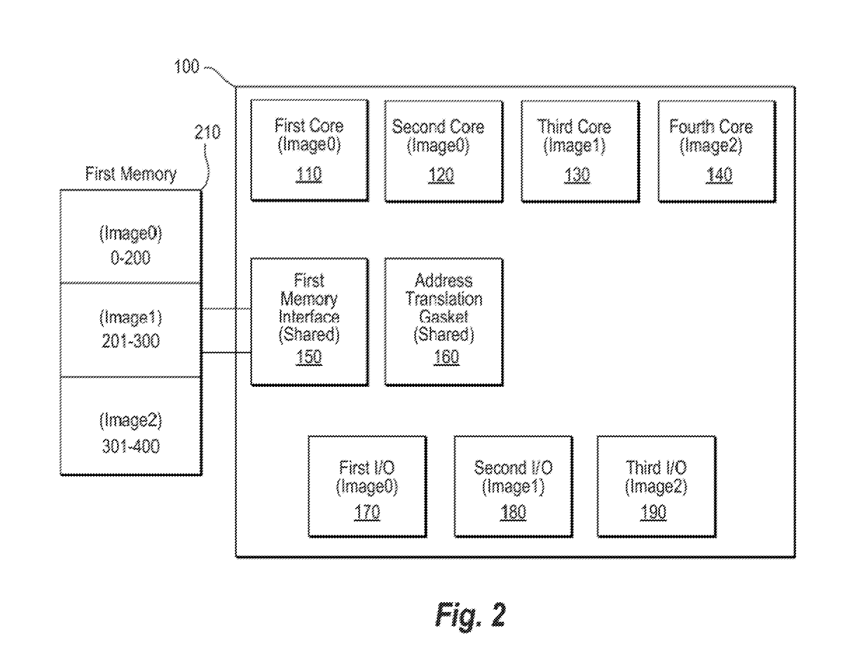

Management logic may be configured to allocate the processor cores (110-140), the memory interface components (150-160), and/or the input/output components (170-190) to the various system images. In some embodiments, one or a group of processor cores may be designated as the “monarch,” and configured to execute the management logic to provide for the allocations. That is, one or a group of processor cores may be responsible for allocating the plurality of processor core components, as well as the memory interface and input/output components, to the various system images. In addition, the monarch may be responsible for, e.g., enabling/disabling the processor core components, allocating shared memory capacity to the system images (discussed in greater detail with respect to FIG. 2), controlling reset functions per core, and/or tracking errors and other relevant events. Enhanced logic within the monarch core(s) and/or within each of the top-level functional blocks may allow isolation between cores, memory address ranges, and the input/output devices. The monarch core(s) may configure the processor 100 into multiple, independent system images (e.g., system image #0, system image #1, and system image #2), with cores or groups of cores enabled and allocated to the system images, along with, e.g., selected address ranges of main memory (not shown) and input/output components (170-190) or a subset of input/output root ports. The monarch core(s) may control reset functions per top level functional unit, such that the on-chip resources may be reconfigured even as other resources continue operation in other system images. The monarch core(s) may further track errors (or other relevant events that impact shared resources) and take appropriate action to notify affected system images. Such tracking logic may be virtualized by the monarch core(s), or physically replicated per system image in the management logic.

In alternative embodiments, a separate management component may be included in the processor 100 to conduct the above-mentioned functionality of the monarch processor core(s) via management logic. Therefore, in that implementation, a monarch processor core or group of processor cores may not be utilized.

FIG. 2 depicts a system 200 in accordance with an embodiment. The system 200 comprises a processor 100 and an attached memory 210. It should be readily apparent that the system 200 depicted in FIG. 2 represents a generalized illustration and that other components may be added or existing components may be removed, modified, or rearranged without departing from the scope of the system 200.

The processor 100 is similar to the processor described above with respect to FIG. 1, and comprises a plurality of processor cores (110-140), a memory interface component 150, an address translation gasket 160, and a plurality of input/output components (170-190). The memory 210 may correspond to any typical storage device that stores data, instructions, or the like. For example, the memory 210 may comprise volatile memory or nonvolatile memory. Examples of volatile memory include, but are not limited to, static random access memory (SRAM) and dynamic random access memory (DRAM). Examples of non-volatile memory include, but are not limited to, electronically erasable programmable read only memory (EEPROM), read only memory (ROM), and flash memory. The memory 210 may be communicatively coupled to the memory interface 150 of the processor 100. This may be accomplished, for example, via a bus between the memory interface and the memory operating based on a double data rate (DDR) interface specification (e.g., DDR3).

The system images (e.g., system image #0, system image #1, and system image #2) and their respective cores (110-140) may share the memory capacity of the memory. That is, a portion of memory capacity of the memory 210 may be assigned to each of the plurality of independent and isolated system images. For example, as shown in FIG. 2, the memory 210 may be shared such that system image #0, system image #1, and system image #2 each utilize a portion of the memory capacity. While the memory 210 may be shared, the inclusion of the address translation gasket 160 interconnected between the processor cores (110-140) and memory interface 150 may give the appearance that each system image has a dedicated memory that is independent of the other system images.

In some embodiments, the memory 210 may be partitioned based on address ranges. For example, system image #0 may be assigned address range 0-200, system image #1 may be assigned address range 201-300, and system image #2 may be assigned address range 301-400. While only one memory is shown (i.e., memory 210), it should be understood that in various embodiments the system images utilize multiple memories that may be different in terms of type, size, speed, and/or other parameters. For example, the system images may utilize a first and second memory with different storage capacities. Furthermore, while FIG. 2 shows that the memory 210 is shared by each system image, it should be understood that each memory does not have to be shared by every system image. For example, one memory may be shared by system image #0 and system image number #1, while another memory may be shared by system image #1 and system image #2. Additionally, one memory may be utilized by only a single system image. As discussed above, this memory capacity distribution may be determined by the monarch processor core(s), or, alternatively, by a management component incorporated in the processor 100.

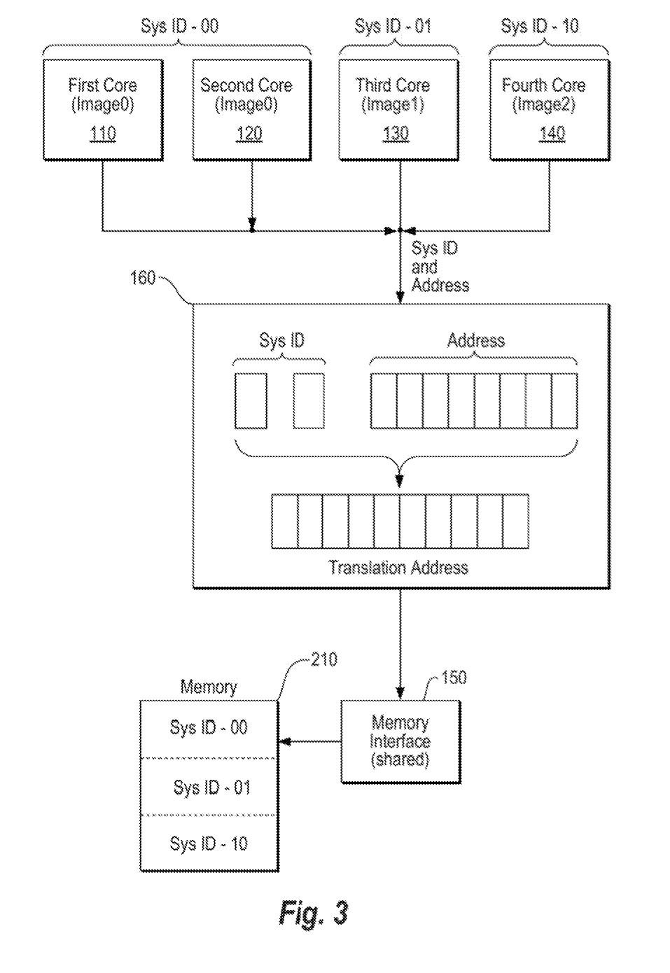

FIG. 3 depicts a block diagram of operations conducted by the address translation gasket 160 is accordance with an embodiment. As discussed above, the address translation gasket is configured to intercept transactions bound for the memory interface component 150, and to generate a translation address based at least in part on the target address and/or system image identifier obtained from the transaction. In the embodiment depicted in FIG. 3, the address translation gasket 160 generates the translation address by treating the system identifier as one or more additional address bits, and by concatenating the one or more additional address bits with the target address to produce the translation address.

More specifically, each system image is assigned a system image identifier. In the system shown in FIG. 3, the first processor core 110 and second processor core 120 are assigned system image identifier “00.” The third processor core 130 is assigned system image identifier “01.” The fourth processor core 140 is assigned system image identifier “10.” These system image identifiers and a target address (e.g., physical/virtual address) are sent with the transactions (e.g., read/write transactions) originating from the processor cores (110-140) and bound for the memory interface 150 and memory 210. The address translation gasket 160 is configured to intercept these transactions (e.g., read/write transactions) and parse out the system image identifier and the target address. The address translation gasket 160 may then utilize the system image identifier as additional bits of address with respect to the target address. For example, the system image identifier may be a two-bit value and the target address may be an eight-bit number. The address translation gasket 160 may concatenate the two values to generate a 10-bit translation address, which is then passed from the address translation gasket 160 to the memory interface 150.

In one implementation of this embodiment, if all the system ID combinations are not in use, a system ID that is not in use may be effectively given to another system ID by choosing to provide an extra address bit to the system ID. For example, if there are assigned system images “00,” “10,” and “11,” and half of the total memory space is to go to system image “00,” when a transaction from system image “00” is provided to too address translation gasket, the address translation gasket may not force use of the second address bit of the system ID (i.e., “0”), but rather allow one more bit of the address to be utilized, and therefore the resulting system ID that is concatenated with the address may be “01” rather than “00.” Put another way, the most significant bit of the system ID may be used, and the next bit of the system ID may be determined by an address bit instead of the second system ID bit.

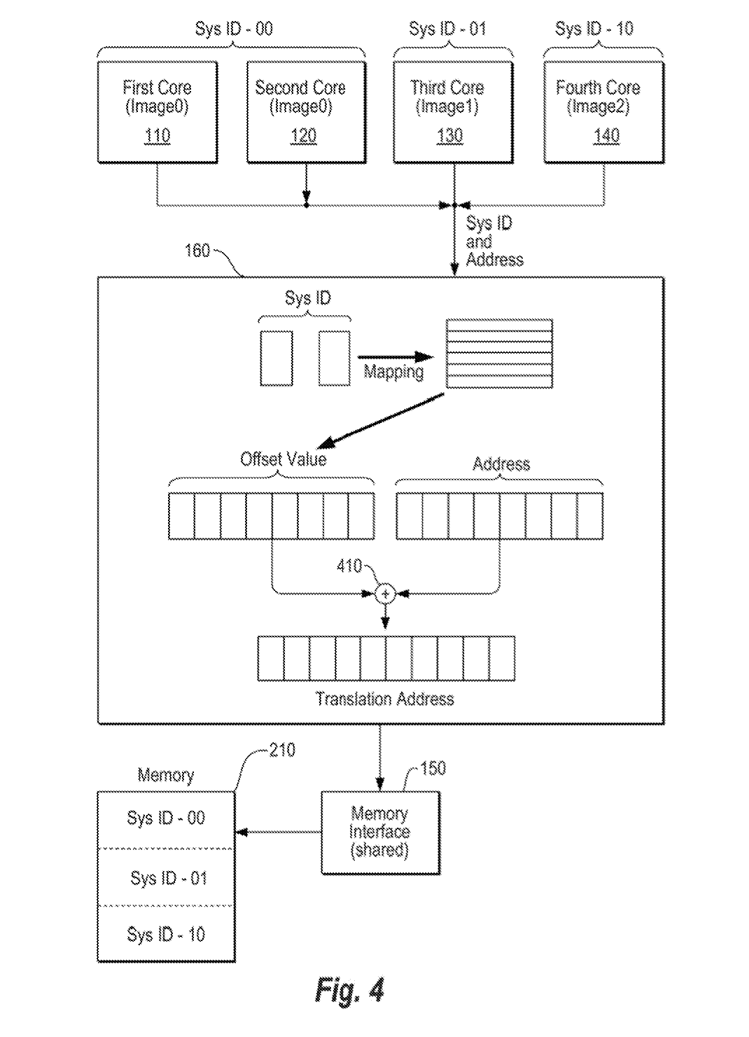

FIG. 4 depicts a block diagram of operations conducted by the address translation gasket 160 is accordance with another embodiment. As mentioned above, the address translation gasket is configured to intercept transactions bound for the memory interface component 150, and to generate a translation address based at least in part on the target address and/or system image identifier obtained from the transaction. In the embodiment depicted in FIG. 4, the address translation gasket 160 generates the translation address by mapping the system identifier to a fixed address offset, and by adding the fixed address offset to the target address to produce the translation address via adder 410.

More precisely, each system image is assigned a system image identifier. In the system shown in FIG. 4, the first processor core 110 and second processor core 120 are assigned system image identifier “00.” The third processor core 130 is assigned system image identifier “01.” The fourth processor core 140 is assigned system image identifier “10.” These system image identifiers and a target address (e.g., physical/virtual address) are sent with the transactions (e.g., read/write transactions) originating from the processor cores (110-140) and bound for the memory interface 150 and memory 210. The address translation gasket 160 is configured to intercept these transactions (e.g., read/write transactions) and parse out the system image identifier and the target address. The address translation gasket 160 may then map the received system image identifier to an offset value, and add the offset value to the received target address via adder 410 to produce the translation address. For example, the address translation gasket 160 may receive a 2-bit system image identifier “00,” and map the system image identifier to an 8-bit offset value of “10110000.” The address translation gasket 160 may then add the offset value of “10110000” to the 8-bit target address via adder 410 to produce the translation address, which is then sent to the memory interface 150. While the example describes the use of an 8-bit offset value, it should be understood that the offset value is flexible and can be any size up to the total target address size required by the full memory address supported by the shared memory 210.

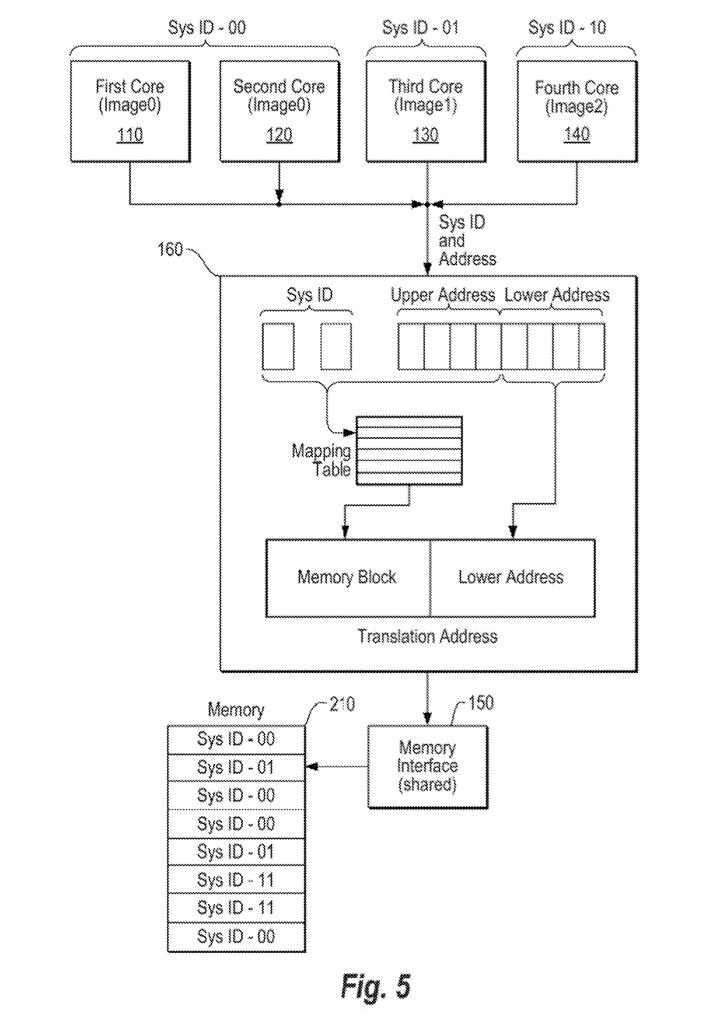

FIG. 5 depicts a block diagram of operations conducted by the address translation gasket 160 is accordance with still another embodiment. As described above, the address translation gasket is configured to intercept transactions bound for the memory interface component 150, and to generate a translation address based at least in part on the target address and/or system image identifier obtained from the transaction. In the embodiment depicted in FIG. 5, the address translation gasket 160 generates the translation address by mapping the system identifier and at least a portion of the target address to an assigned portion of memory.

In particular, each system image is assigned a system image identifier. In the system shown in FIG. 5, the first processor core 110 and second processor core 120 are assigned system image identifier “00.” The third processor core 130 is assigned system image identifier “01.” The fourth processor core 140 is assigned system image identifier “10.” These system image identifiers and a target address (e.g., physical/virtual address) are sent with the transactions (e.g., read/write transactions) originating from the processor cores (110-140) and bound for the memory interface 150 and memory 210. The address translation gasket 160 is configured to intercept these transactions (e.g., read/write transactions) and parse out the system image identifier and the target address. The address translation gasket 160 may then provide the system image identifier and at least a portion of the target address to a mapping table which produces a memory bock address based thereon. For example, and as shown in FIG. 5, the system image identifier bits and the upper order address bits of the target address may be mapped to a memory block, and the memory block may be combined with the lower order address bits of the target address to produce the translation address, which is passed to the memory interface 150. Among other things, this translation option allows the memory allocated to a respective system image to be contiguous or non-contiguous portions of memory.

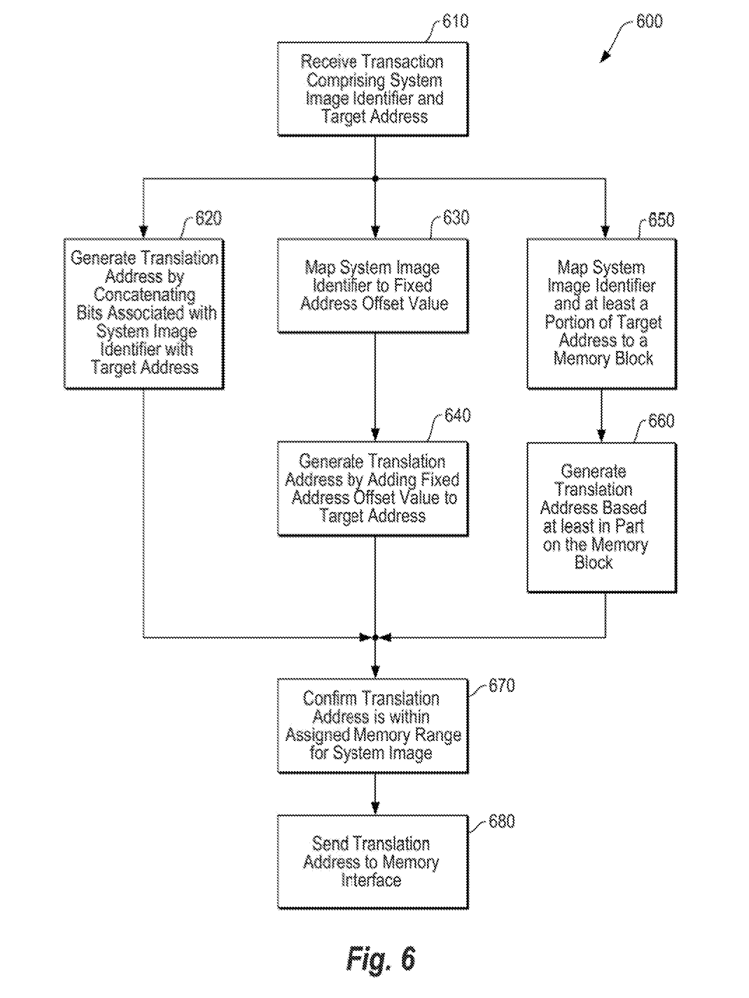

FIG. 6 depicts a process flow diagram 600 in accordance with an embodiment. If should be understood that the processes depicted in FIG. 6 represents generalized illustrations, and that other processes may be added or existing processes may be removed, modified, or rearranged without departing from the scope and spirit of the present disclosure. Furthermore, it should be understood that the processes may represent executable instructions, logic, or functionally equivalent circuits that may cause a device such the processor 100, and more particularly the address translation gasket 160, to respond, to perform actions, to change states, and/or to make decisions. FIG. 6 is not intended to limit the implementation of the described embodiments, but rather to illustrate functional information one skilled in the art could use to design/fabricate circuits, firmware, and/or other hardware and software to perform the illustrated processes.

The process may begin at block 610, when the address translation gasket 160 receives a transaction comprising a system image identifier and a target address. The address translation gasket 160 may then proceed to translate the target address at block 620 by treating the system image identifier as one or more additional address bits, and by concatenating the one or more additional address bits with the target address to produce the translation address. Alternatively, the address translation gasket 160 may translate the target address at block 630 by mapping the system image identifier to a fixed address offset value, and at block 640 adding the fixed address offset value to the target address to produce the translation address. Alternatively, the address translation gasket 160 may translate the target address at block 650 by mapping the system image identifier and at least a portion of the target address to a memory block, and at block 660 generating the translation address based at least in part on the memory block. Regardless of the manner utilized to translate the address and obtain the translation address, at block 670, the address translation gasket checks the translation address to confirm that the translation address is within the address range assigned to the particular system image. Once this point is confirmed, at block 680, the translation address is sent from the address translation gasket 160 to the memory interface 150.

The present disclosure has been shown and described with reference to the foregoing exemplary embodiments. It is to be understood, however, that other forms, details, and embodiments may be made without departing from the spirit and scope of the disclosure that is defined in the following claims.

What is claimed is:

1. A processor comprising:
a plurality of processor core components, wherein each processor core component is assigned to one of a plurality of system images, and wherein the plurality of system images share a common memory component by at least utilizing an address translation gasket to maintain separation between memory regions assigned to each of the plurality of system images;
a memory interface component shared by the plurality of independent system images; and
the address translation gasket to
intercept transactions bound for the memory interface component from the plurality of processor core components, wherein each transaction comprises a system image identifier and a target address,
generate a translation address based at least in part on the system identifier and the target address, and
send the translation address to the memory interface component.

2. The processor of claim 1, wherein the address translation gasket is further to check the translation address to confirm that the translation address is not outside the memory region assigned to the system image associated with the system identifier before sending the translation address to the memory interface component.

3. The processor of claim 1, wherein the address translation gasket is further to conduct reverse translation on transactions received from the memory interface component and bound for one of the plurality of processor core components.

4. The processor of claim 1, wherein the address translation gasket is to generate the translate address based at least in part on the system identifier and target address by treating the system identifier as one or more additional address bits, and by concatenating the one or more additional address bits with the target address to produce the translation address.

5. The processor of claim 1, wherein the address translation gasket is to generate the translation address based at least in part on the system identifier and target address by mapping the system identifier to a fixed address offset, and by adding the fixed address offset to the target address to produce the translation address.

6. The processor of claim 1, wherein too address translation gasket is to generate the translation address based at least in part on the system identifier and target address by mapping the system identifier and at least a portion of the target address to an assigned portion of memory.

7. The processor of claim 1, wherein the processor is fabricated with a single die.

8. The processor of claim 1, wherein the memory regions assigned to the plurality of system images are dynamically reassignable.

9. A processor comprising:
a plurality of processor core components each assigned to one of a plurality of system images, wherein the plurality of system images share a common memory component by at least utilizing an address translation gasket to maintain separation between memory regions assigned to each of the plurality of system images; and
the address translation gasket to intercept transactions bound for a memory interface component from the plurality of processor core components, and intercept transactions bound for the plurality of processor core components from the memory interface component,
wherein the address translation gasket is to generate translation addresses for the transactions bound for the memory interface component based at least in part on a system image identifier and address associated with the transactions bound for the memory interface component, and
wherein the address translation gasket is to generate translation addresses for the transactions bound for the plurality of processor core components.

10. The processor of claim 9, further comprising a management component to assign each of the plurality of processor core components to one of a plurality of independent system images.

11. The processor of claim 9, wherein one of the plurality of processor core components is to assign each of the plurality of processor core components to one of a plurality of independent system images.

12. A processor comprising:
a plurality of processor core components each assigned to one of a plurality of system images, wherein the plurality of system images share a common memory component by at least utilizing an address translation gasket to maintain separation between memory regions assigned to each of the plurality of system images;
a memory interface component shared by the plurality of independent system images; and
the address translation gasket to intercept transactions bound for the memory interface component from the plurality of processor core components, wherein the transactions each comprise a system image identifier and a target address, and wherein the address translation gasket is to generate a translation address based at least in part on the system identifier and the target address by at least one of
treating the system identifier as one or more additional address bits and concatenating the one or more additional address bits with the target address to produce the translation address,
mapping the system identifier to a fixed address offset, and adding the fixed address offset to the target address to produce the translation address, and
mapping the system identifier and at least a portion of the target address to an assigned portion of memory.

13. The processor of claim 12, wherein the address translation gasket is further to check the translation address to confirm that the translation address is not outside a memory range assigned to the system image associated with the system identifier.

14. The processor of claim 12, wherein the address translation gasket is further to conduct reverse translation on transactions received from the memory interface component and bound for one of the plurality of processor core components.

15. The processor of claim 12, wherein the memory regions assigned to the plurality of system images are dynamically reassignable.
